(19) United States
(12) Patent Application Publication
(10) Pub. No.: US 2004/0193462 A1
(43) Pub. Date: Sep. 30, 2004

(54) System, method and apparatus to manage infrastructure asset information

(76) Inventor: Peter M. Beasley, Dallas, TX (US)

Correspondence Address: CHALKER FLORES, LLP, 12700 PARK CENTRAL, STE. 455, DALLAS, TX, 75251, US

(21) Appl. No.: 10/713,369

(22) Filed: Nov. 14, 2003

Related U.S. Application Data
(60) Provisional application No. 60/459,013, filed on Mar. 31, 2003.

(51) Int. Cl. G06F 17/60

(52) U.S. Cl. 705/7

(57) ABSTRACT

The present invention provides a system, method and apparatus for managing an infrastructure by providing a database, processing one or more user requests to display or report information stored in the database and updating the database as assets or asset related items are procured, implemented, changed or disposed. The database contains two or more records, each record having a unique identifier and one or more data fields representing attributes of an asset or asset related item within the infrastructure. All of the records are linked to one another in a closed-loop hierarchical manner in accordance with one or more business rules, which define how the assets and asset related items are interconnected or how one or more users use the assets and asset related items or how one or more users use the information stored in the one or more data fields associated with the assets and asset related items.

### PRIORITY CLAIM

This patent application is a non-provisional patent application of U.S. provisional patent application serial No. 60/459,013 filed on Mar. 31, 2003.

### TECHNICAL FIELD OF THE INVENTION

The present invention relates generally to the field of computer systems and, more particularly, to a system, method and apparatus to manage infrastructure asset information.

### BACKGROUND OF THE INVENTION

Various asset management systems and programs have been developed (U.S. Pat. No. 6,502,096). These systems typically focus on tracking the location of a device (U.S. Pat. No. 6,507,869), locating devices using electronic means (U.S. Pat. Nos. 6,504,825 and 6,286,044) or auto-discovering (U.S. Pat. No. 6,220,768) the existence of a device. Other asset management or management systems have been created for specialized cases (U.S. pat. app. Ser. No. 20020174017—locating assets to reduce property tax) (U.S. Pat. No. 6,067,030—managing telecommunications and network infrastructures). These systems, however, are complex, expensive and fail to increase the likelihood the system contains accurate data. There is, therefore, a need for an asset management system for infrastructure systems that is inexpensive, simple and increases the likelihood the system contains accurate data.

### SUMMARY OF THE INVENTION

The present invention provides a method, computer program, relational database, system and apparatus to manage information related to infrastructure assets. The present invention uses a combination of techniques that increases the likelihood that the system contains accurate, complete data and in a fashion that relates the information of infrastructure asset, asset related items and sub-elements through a hierarchy to the people who use the information. The present invention is specialized to take advantage of the unique characteristics of infrastructure systems using a dual closed-loop structure to represent the assets in: (1) a hierarchical fashion patterned after the actual connections in the infrastructure; and (2) the life cycle of the assets. The asset and associated information are also related to the people who use them. As a result, the present invention is simpler and less complex than auto-discovery software or auto-location devices. The present invention has inherent checks and balances (e.g., storing the information in a closed-loop fashion, providing reporting and workflow techniques, etc.) that increase its accuracy and usability over other generic asset management systems.

More specifically, the present invention provides a system for managing an infrastructure that includes a network, one or more client computers communicably coupled to the network, a user interface communicably coupled to each client computer, one or more server computers communicably coupled to the network, a database communicably coupled to the server computer and a computer program. The database contains two or more records, each record having a unique identifier and one or more data fields representing attributes of an asset or asset related item within the infrastructure. In addition, all of the records are linked to one another in a closed-loop hierarchical manner in accordance with one or more business rules. The computer program is embodied on a computer readable medium and is executed by the one or more server computers to manage the infrastructure using the database and provide the one or more client computers with access to the database. The one or more business rules define how the assets and asset related items are interconnected or how one or more users use the assets and asset related items or how one or more users use the information stored in the one or more data fields associated with the assets and asset related items.

The present invention also provides an apparatus for managing an infrastructure that includes a computer, a user interface communicably coupled to the computer, a database communicably coupled to the computer and a computer program. The database contains two or more records, each record having a unique identifier and one or more data fields representing attributes of an asset or asset related item within the infrastructure. In addition, all of the records are linked to one another in a closed-loop hierarchical manner in accordance with one or more business rules. The computer program is embodied on a computer readable medium and is executed by the computer to manage the infrastructure using the database. The one or more business rules define how the assets and asset related items are interconnected or how one or more users use the assets and asset related items or how one or more users use the information stored in the one or more data fields associated with the assets and asset related items.

In addition, the present invention provides a method for managing an infrastructure by providing a database, processing one or more user requests to display or report information stored in the database and updating the database as assets or asset related items are procured, implemented, changed or disposed. The database contains two or more records, each record having a unique identifier and one or more data fields representing attributes of an asset or asset related item within the infrastructure. In addition, all of the records are linked to one another in a closed-loop hierarchical manner in accordance with one or more business rules. The one or more business rules define how the assets and asset related items are interconnected or how one or more users use the assets and asset related items or how one or more users use the information stored in the one or more data fields associated with the assets and asset related items. The database can be created by identifying one or more boundaries for the infrastructure, identifying the assets within the boundaries, identifying the items related to the assets, determining the attributes associated with each asset and asset related item, determining the business rules for how the assets and related items are linked together, and creating each record and storing the record in the database in a closed-loop hierarchical manner in accordance with the business rules. Moreover, the database can be customized, upgraded, validated or increased by adding additional assets, related items, attributes, users or increasing a boundary. These methods can be implemented using a computer program embodied on a computer readable medium wherein the steps are performed by one or more code segments.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a block diagram of system in accordance with one embodiment of the present invention;

FIG. 2A is a flowchart illustrating the creation of a database in accordance with one embodiment of the present invention;

FIG. 2B is a flowchart illustrating the management of an infrastructure in accordance with one embodiment of the present invention;

FIG. 2C is a flowchart illustrating improving the database in accordance with one embodiment of the present invention;

FIG. 3A is a block diagram illustrating an example of the present invention as it is applied to a network infrastructure system;

FIG. 3B is a block diagram illustrating an example of the present invention as it is applied to waterworks infrastructure system;

FIGS. 4A, 4B, 4C and 4D are block diagrams illustrating the use of business rules in one embodiment of the present invention;

FIG. 5 is a block diagram illustrating the closed-loop life cycle of infrastructure assets in accordance with one embodiment of the present invention;

FIG. 6A is a block diagram illustrating counter-balancing closed-loops in accordance with one embodiment of the present invention;

FIG. 6B is a block diagram illustrating counter-balancing system users in accordance with one embodiment of the present invention;

FIG. 7 is a block diagram illustrating entry of data the database from other sources in accordance with one embodiment of the present invention;

FIGS. 8A and 8B are block diagrams illustrating various examples of data verification in accordance with one embodiment of the present invention; and

FIG. 9 is a screen shot of a system asset management system in accordance with one embodiment of the present invention.

### DETAILED DESCRIPTION OF THE INVENTION

While the production and application of various embodiments of the present invention are discussed in detail below in relation to authentication and processing of commercial and security related transactions, it should be appreciated that the present invention provides many applicable inventive concepts that may be embodied in a wide variety of specific contexts. The specific embodiments discussed herein are merely illustrative of specific ways to make and use the invention and do not delimit the scope of the invention. A working embodiment of the present invention is the System Asset Management System software program from Net Watch Solutions, Inc.

The present invention provides a method, computer program, relational database, system and apparatus to manage information related to infrastructure assets. The present invention uses a combination of techniques that increases the likelihood that the system contains accurate, complete data and in a fashion that relates the information of infrastructure asset, asset related items and sub-elements through a hierarchy to the people who use the information. The present invention is specialized to take advantage of the unique characteristics of infrastructure systems using a dual closed-loop structure to represent the assets in: (1) a hierarchical fashion patterned after the actual connections in the infrastructure; and (2) the life cycle of the assets. The asset and associated information are also related to the people who use them. As a result, the present invention is simpler and less complex than auto-discovery software or auto-location devices. The present invention has inherent checks and balances (e.g., storing the information in a closed-loop fashion, providing reporting and workflow techniques, etc.) that increase its accuracy and usability over other generic asset management systems.

Unlike generic asset management systems, the present invention does not overlook the reality that, in aggregate, infrastructure assets or devices do not change frequently. For example, in a city infrastructure, new roads are built and old ones repaired, but when the entire infrastructure—roads, electrical systems, and waterworks—is considered, only a small percentage of the overall total changes during normal operations. Moreover, prior art systems fail to incorporate the fact that infrastructure systems are managed and supported by a limited number of people—there is typically a managing agency. For example, cities do not allow just anyone to connect to the water works system, the highway system, or to the public switched telephone network (“PSTN”). Likewise, most organizations do not allow just anyone to connect to computer infrastructures. In recognition of these deficiencies, the present invention relies on the fact that infrastructures are closed-loop systems—the connected devices are integral to allow end-devices to operate. For instance, in a waterworks system, if a supply pipe is removed, water will run-out of the entire system and down-stream faucets will be affected. Likewise, a telephone system central office is an integral part for the end-points—home telephones—to operate. If the telephone central office is removed, outlying telephones will be affected. Similarly, in a power system, removal of an electrical power station or transmission lines will affect electricity distribution to other locations. Accordingly, infrastructures have definable boundaries and sub-elements that connect together to make-up the entire system. For example, a picture puzzle contains boundary pieces and individual pieces. Just like a puzzle, each piece of an infrastructure is related to the other elements of the system—one piece does not exist outside the boundaries of the entire system.

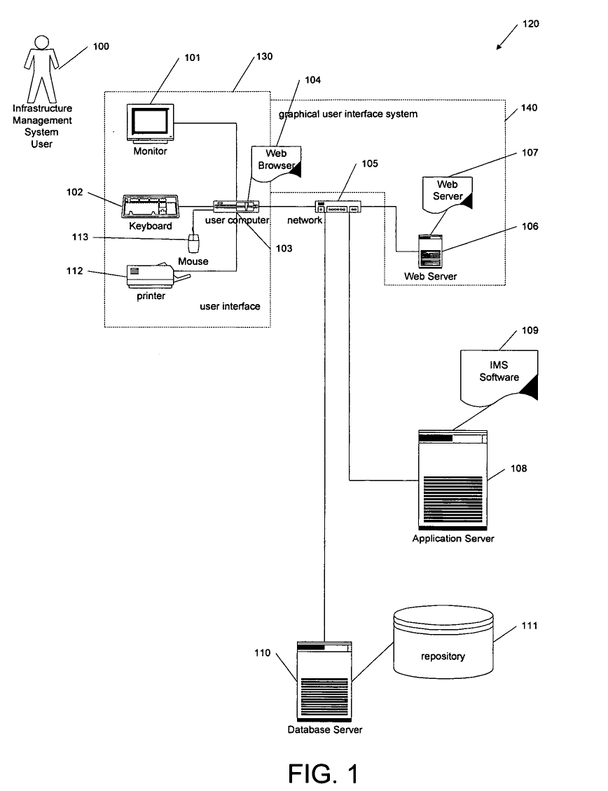

Now referring to FIG. 1, a block diagram of an Infrastructure Management System (“IMS”) 120 in accordance with one embodiment of the present invention is shown. The system 120 includes a network 105, one or more client computers 103 communicably coupled to the network 105, a user interface 130 (101, 102, 112 and/or 113) communicably coupled to each client computer 103, one or more server computers 106, 108 and/or 110 communicably coupled to the network 105, a database or repository 111 communicably coupled to the server computer 110 and a computer program 104, 107 and/or 109. The database 111 contains two or more records, each record having a unique identifier and one or more data fields representing attributes of an asset or asset related item within the infrastructure. In addition, all of the records are linked to one another in a closed-loop hierarchical manner in accordance with one or more business rules. The one or more business rules define how the assets and asset related items are interconnected or how one or more users use the assets and asset related items or how one or more users 100 use the information stored in the one or more data fields associated with the assets and asset related items.

The computer program 109 (“IMS Software”) is embodied on a computer readable medium and is executed by the one or more server computers 108 to manage the infrastructure using the database 111 and provide the one or more client computers 103 with access to the database 111. In this example, the IMS Software 109 operates on an application server 108 that provides access to database 111 via database server 110 and network 105. In a networked scenario, a graphical user interface system 140 (web browser 104, web server 106 and web server application 107) can be used to provide the user 100 with access to the IMS Software 108 via the user computer 103. The server computers 106, 108, 110 and computer programs 107, 109 and database 111 can all be implemented within the user computer 103 or distributed over a network. The network 105 can be a local area network (“LAN”), wide area network (“WAN”) or the Internet. The user computer 103 typically includes a monitor 101 to display information and a keyboard 102 for data input. A connected printer 112 and mouse 113 are also useful.

As previously stated, the repository or database 111 contains two or more contains two or more records, each record having a unique identifier and one or more data fields representing attributes of an asset or asset related item within the infrastructure. The one or more data fields may also represent attributes of a sub-element for one or more assets. The attributes may include an asset name, manufacturer name, make, model number, serial number, description, purchase date, expiration date, purchase cost or operating characteristics. The asset related items may include places (e.g., physical sites, locations, etc.), connections (e.g., electrical connections, physical connections, logical connections, communication links, interfaces, junctions, circuits, patch panels, etc.), contracts (e.g., leases, title documents, maintenance contracts, license agreements, clients contracts, resource allocation, service-level agreements, etc.), documentation (e.g., support documents, maintenance schedules, procedural documentation, operational documentation, policy documentation, etc.) or financials (e.g., purchase records, repair records, warranties, operational costs, charge-backs, down-time costs, etc.). In addition, each record may include life cycle information about the asset or asset related item (e.g., procurement, usage, modification, decommission, salvage information, etc.).

The present invention can also be implemented as an apparatus for managing an infrastructure that includes a computer, a user interface communicably coupled to the computer, a database communicably coupled to the computer and a computer program. The database contains two or more records, each record having a unique identifier and one or more data fields representing attributes of an asset or asset related item within the infrastructure. In addition, all of the records are linked to one another in a closed-loop hierarchical manner in accordance with one or more business rules. The computer program is embodied on a computer readable medium and is executed by the computer to manage the infrastructure using the database. The database and computer program are the same as previously described.

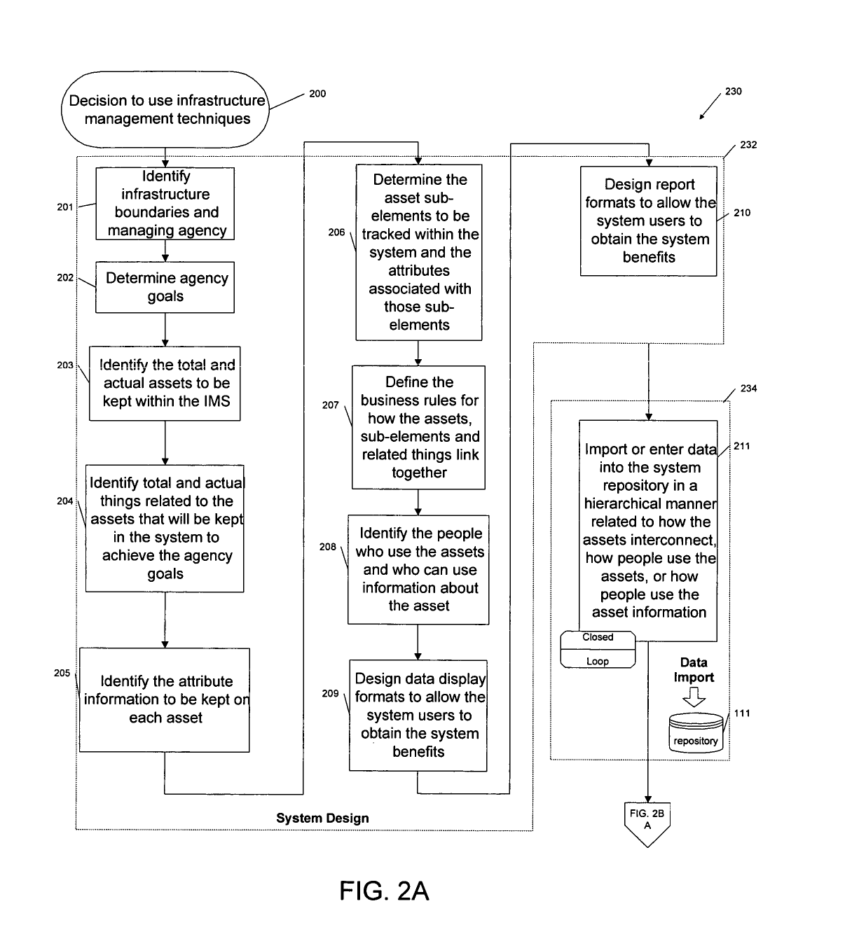

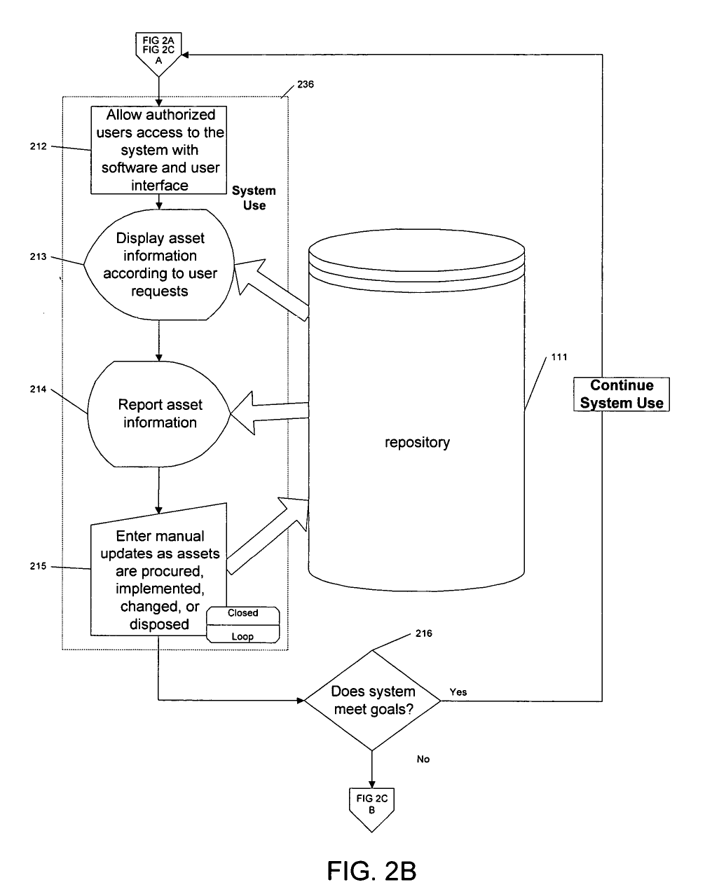

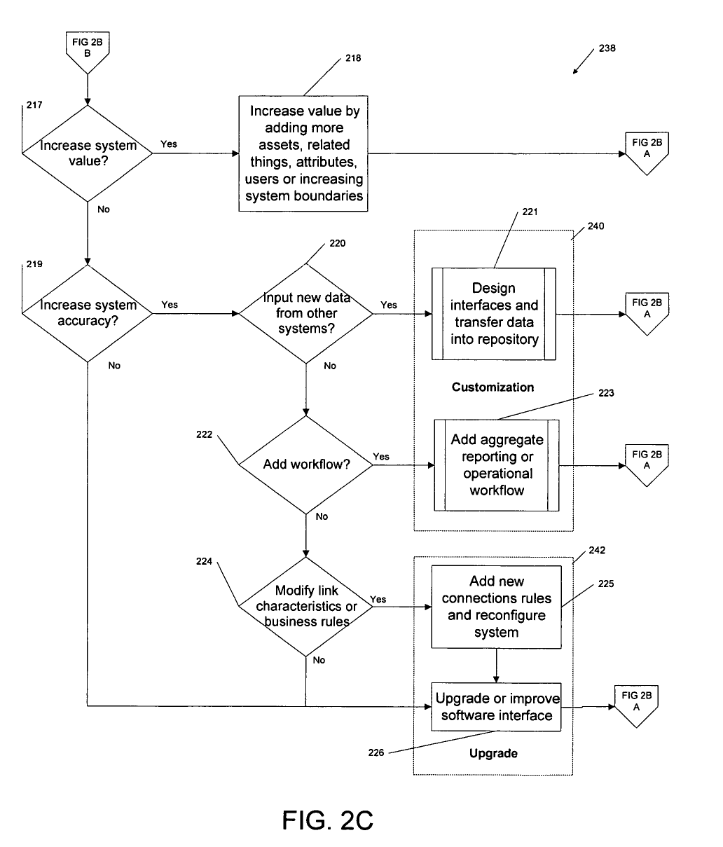

Referring now to FIG. 2A, a flowchart illustrating a method 230 for creating a database or repository 111 in accordance with one embodiment of the present invention is shown. This method 230 includes three phases: (1) the decision to use infrastructure management techniques in block 200; (2) designing the system in block 232; and importing or entering the data into the database 111 in block 234. Typically, when information system (“IS”) organizations decide to implement an information technology asset management program, they face a specific problem that has led them to conclude they need a way to track their infrastructure assets. Closed-loop infrastructure systems typically have an organization or organizational rules that govern the management or support of the infrastructure. These organizations also have a boundary or scope of influence. As a result, the first step in designing the infrastructure management system is to determine the managing agency and their boundary of interest in block 201. The boundaries of the system identify a controlling organization or organizations. Thereafter, the goals of the managing agency or organization are determined in block 202. This list typically identifies the benefits the organization wants to achieve from the IMS. These goals may be to inventory all of the infrastructure assets, to generate management reports that show license expirations, or perhaps generate cost charge-back reports based on the assets used by customers.

Next, all of the assets (“T”) in the closed-loop infrastructure that are to be represented in the IMS are identified in block 203 and all the things or items related (“RT”) to these assets are identified in block 204. A picture puzzle box, for example, typically identifies the total number of pieces—500, 1,000, or 2,500 piece puzzles. The same is true for infrastructures, where the system is composed of a total finite number of elements (“T”) that are all linked together. Note that of the list of all of the assets, the organization may only decide to track or include a sub-set of the total assets within the IMS. For instance, in a closed-loop electrical system the assets include transformers, power lines, power poles, power stations, rectifiers, and many other elements. In this example, to minimize implementation costs, the managing agency may chose not to include rectifiers in the initial IMS implementation.

The asset related items may include places (e.g., physical sites, locations, etc.), connections (e.g., electrical connections, physical connections, logical connections, communication links, interfaces, junctions, circuits, patch panels, etc.), contracts (e.g., leases, title documents, maintenance contracts, license agreements, client contracts, insurance policies, resource allocation, service-level agreements, etc.), documentation (e.g., support documents, maintenance schedules, procedural documentation, operational documentation, policy documentation, etc.) or financials (e.g., purchase records, repair records, warranties, operational costs, charge-backs, down-time costs, etc.). Just like the assets, the organization decides which of the total asset related items will be tracked within the system. In a computer network infrastructure, for example, the asset related items may include equipment lease agreements, maintenance contracts, license agreements, service level agreements, support documentation, network schematics and standards policies.

The assets and related items have one or more attributes. These include fields of information that further describe the asset. The attributes may include an asset name, manufacturer name, make, model number, serial number, description, speed rating purchase date, expiration date, purchase cost, operating characteristics or other data. In addition, each record may include life cycle information about the asset or asset related item (e.g., procurement, usage, modification, decommission, salvage information, etc.). As a result, the managing organization identifies which attributes will be stored within the IMS in block 205. For example, in working a puzzle, people often first sort the pieces based on attributes of the pieces. One attribute may be whether the piece is an edge-piece. Another attribute may be the color or design on the puzzle piece. Arranging the pieces first, makes assembly of the picture easier.

The present invention also recognizes that closed-loop infrastructures are comprised of interconnecting sub-elements. For instance, in a roadwork system, the sub-elements could be defined as single-lane roads, dual-lane streets, multi-lane parkways and freeways. Likewise, a communications system has transmitters, transmitting antennas, radio frequencies, receiving antennas and receiver sub-elements. Similarly, a computer network may include servers, switches, routers, CSU/DSUs and network circuits. Accordingly, the next step in the process 230 is for the managing agency to define the sub-elements of the system to be tracked and the attributes associated with those sub-elements in block 206. Note that these sub-elements may also have sub-elements. For instance, in a computer network, a server has a network interface as a sub-element to the computer. The network interface has an IP Address as a sub-element. The network interface has attributes, which may include the model number, software driver, protocol type, communication speed, or other defining attributes.

In addition, closed-loop infrastructures are connected according to an associated business-rule dependent hierarchy. The governing agency defines or knows of the rules on how the infrastructure sub-elements interconnect. Unlike an end-device, such as a home-owners water softener appliance, for example, that is connected on the end of the water work system, internal infrastructure elements are connected and built-together in a logical fashion for the entire system to operate properly. Accordingly, the next step in the process 230 is to define the business rules for how the assets (T), asset related items (RT) and sub-elements interrelate or link together in block 207. In many cases these relationships are defined based on the technology used in the infrastructure system, or they are sometimes defined by the managing agency.

Another feature of the present invention is that information elements are related, in a hierarchy, to people. It is important to remember that the value of the infrastructure comes from the services it provides to people. These devices have no value in and of themselves; the value comes from their relation to people or the business that use the infrastructure system. Accordingly, the asset or asset information is linked to the people who use the asset or asset information indicating relationships. For instance, the value of an electronic router comes from its ability to transmit data that people ultimately use. The value of a server comes from the data it stores and manipulation of information that people ultimately use. The present invention relates asset information in a hierarchical manner for the practical use by people. For example, information on a network device maintenance contract is useful to the support people who maintain network devices. The information on the maintenance contract is valuable as it is related to the device covered in the maintenance contract. In this example, having ready access to this data is important for support personnel. Accordingly, the next step in the process 230 is to identify the people who use the infrastructure assets and use the infrastructure asset information in block 208.

With most infrastructure systems, many people can obtain value from the asset information. This can include support people, system management personnel, capacity planners, accountants and system users. Not everyone needs every element of the data, but service-related or aggregate data is useful to many diverse groups of individuals. As a result, there is a total number of users and users groups (“TU”) who can obtain value from the information in the system. At one extreme, if no one uses the system, the information has no value. In the computer network infrastructure scenario, the database administrators can obtain value from information on how the database servers are configured. Likewise, application developers may want to know how much disk space is attached to a given server. Each of these groups of individuals has preferred methods for displaying asset information. Accordingly, the next step in the process 230 is to design data display formats to allow system users to retrieve data in a manner that meets the organization's goals in block 209.

Not everyone who can obtain benefits from the IMS needs to have access to a computer—they can get benefits from printed reports. As a result, it is important to design data display formats and data reports in a manner that are useful to the people who use the system. The IMS is designed to meet the needs of people and business. It is equally important to relate information in the IMS to the people and businesses that use the information. Accordingly, the next step in the process 230 is to design data report formats that allow the system users to retrieve data in a manner that meets the organization's goals in block 210.

Once the system is designed and constructed in block 232, the next step is to enter or import data about the assets, sub-elements, related items and attributes into the IMS repository or database 211 in block 211. Again, the data is stored in a hierarchical relationship based on how the information is interconnected or how people use the asset, or use the information. When the data is stored in this fashion, the information is in a closed-loop—where information is related to other information in the system, or related to a system boundary or related to a person. Once the IMS system is constructed (e.g., implementation of the IMS apparatus or system in FIG. 1 (101, 102, 103, 104, 105, 106, 107, 109, 110, 112); construction of the IMS Software Program 109 (FIG. 1); construction of the IMS database or repository 111 (FIG. 1 and 2A); and entry or importation of the data on the infrastructure 211 (FIG. 2A)), the system is ready to be used to manage the infrastructure as will be described below in reference to FIG. 2B.

In summary, the database can be created by identifying one or more boundaries for the infrastructure (block 201), identifying the assets within the boundaries (block 203), identifying the items related to the assets (block 204), determining the attributes associated with each asset and asset related item (block 205), determining the business rules for how the assets and related items are linked together (block 206), and creating each record and storing the record in the database in a closed-loop hierarchical manner in accordance with the business rules (block 211). The additional or optional steps may include: identifying a managing agency (block 201) and determining one or more goals for the managing agency (block 202); determining one or more sub-elements for the assets and one or more attributes associated with the sub-elements (block 206) and determining one or more business rules for how the sub-elements and assets are linked together (block 207); identifying one or more people who use the assets (block 208); identifying one or more people who use information about the asset (block 208); or designing data display and report formats (block 209).

As will be appreciated by one skilled in the art, an experienced computer programmer and an experienced computer database designer can construct the IMS Software Program 109 (FIG. 1) and IMS Relational Database repository 111 in a fashion that meets the design criteria. Many of the design criteria will be common for common infrastructure systems. For instance, most computer network infrastructures will have similar assets—routers, switches, servers, etc. Likewise, most water work infrastructures will have similar assets—water towers, water pump stations, water pipes, etc.

It is possible for a software manufacturer to make specialized infrastructure management systems in keeping with the present invention that apply to various infrastructure systems—computer networks, water works, broadcast communications, telephony, electricity power distribution, transportation systems, etc. These specialized systems could be customized by the software manufacturer or by the managing agency in various ways—to add various asset attributes, to remove or define asset types, to add related information records, to specify users or groups of users, to modify display or report formats.

Now referring to FIG. 2B, a flowchart illustrating the process 236 for managing an infrastructure in accordance with one embodiment of the present invention is shown. The IMS Software Program 109 (FIG. 1) allows the authorized users to use the system in block 212. The user 100 (FIG. 1) can access the database 111 using the IMS Software Program 109 (FIG. 1) to display asset information in block 213 or prints reports in block 214 based on user requests. As previously discussed, the present invention captures data about an asset at each stage of the asset's existence or life cycle in block 215 (e.g., procurement, usage, modification, decommission and salvage information). People know information about assets when they are purchased, when they are implemented, when they change, and when they are disposed. When information is captured at each stage of the asset's life cycle, there is no need to auto-discover the existence of the device. Hence, the present invention eliminates the necessity of such auto-discovery, auto-tracking, or auto-location techniques. If the system meets the managing agency's goals, as determined in decision block 216, use of the system is continued and process 236 continues. If, however, the system does not meet the managing agency's goals, as determined in decision block 216, the database is improved as will be described in reference to FIG. 2C.

In summary, the present invention provides a method for managing an infrastructure by providing a database 111, processing one or more user requests to display or report information stored in the database (blocks 213 and 214) and updating the database as assets or asset related items are procured, implemented, changed or disposed (block 215).

Referring now to FIG. 2C, a flowchart illustrating a method 238 for improving the database 111 in accordance with one embodiment of the present invention is shown. Situations may arise when additional value is desired from the system or the system becomes inaccurate. The biggest risk in implementing asset management techniques is that staff and procedures must be kept in place to keep the system updated. If the system is not kept current with accurate data, the managing agency's goals cannot be achieved. The present invention, however, significantly reduces the risk of disuse due to inaccuracy.

There are a total number of users who can obtain value from the information in the system. At one extreme, if no one uses the system the information in the system is valueless. Conversely, the more people who use the system, the more valuable the infrastructure management system becomes.

Apart from the sub-element assets themselves, there is valuable information in things related to the assets. These related things or items (“RT”) enhance the usability of the system, or conversely detract from the system if they are not maintained within the system. If people are required to go to file cabinets or to other computer programs to get information related to assets, this external information retrieval minimizes the use of the IMS. Conversely, the more reasons people need to use the IMS, the more people will get value from the system. As the number of related things included in the infrastructure management system increase, more people can derive value from the system. As the number of assets (“T”) and the number of related things (“RT”) in the system increases, the number of potential users (“TU”) will increase.

Changing the boundaries of the system often brings about changes in all of these areas. For instance, a computer network infrastructure IMS may have been initially implemented without telephony equipment or without database information. Adding telephony equipment would possibly bring the telephone support people in as system users. Adding the database information would bring in the database administrators as system users. Each of these additions would have associated assets, related things and new attributes to maintain within the IMS.

Certainly, there are limits on how many assets, related items, and users should be kept within the system. The IMS is an information management tool and this focus should be maintained. Accordingly, the boundaries of the system should not take-on or include extraneous functions that are better served in other types of systems. Including fault detection, intruder detection, and network modeling techniques into the system undermine the intent to be a low-cost, simple method to store information on infrastructure assets.

Data inaccuracies come from input errors and from changes that occur with the asset that are not updated within the system. With any manual system with people involved, data errors can occur. The present invention includes three features to minimize data inaccuracies. First, the IMS Software 109 (FIG. 1) can be constructed to minimize data input errors. Rather than allow people to enter common data fields, these standard items should be selected from a menu choice. A system administrator would then maintain the menu choice list. This reduces the possibility for input errors. Also, the IMS Software 109 (FIG. 1) should verify data when it is input. There should be checks to ensure that mandatory data is entered, that numeric information is entered in a numeric format, and that other information conforms to standard criteria—i.e. date information must be entered in a date format, a zip code format must be entered in a proper format, a phone number must be entered in a proper format. When unique names are required, the IMS Software 109 (FIG. 1) should first verify that the entered name is unique before storing it in the repository.

Second, the IMS Software 109 (FIG. 1) can incorporate numerous features to check the accuracy of information that is changed or deleted from the repository. For instance, the IMS Software 109 (FIG. 1) can automatically change the status attribute of a device from Active to Inactive when it is disconnected from the infrastructure. When a device is deleted, the IMS Software 109 (FIG. 1) can simultaneously delete the associated interrelated asset information. For instance, if a server is removed from a computer network infrastructure all of the applications on the server are also removed from the infrastructure.

Third, reducing the amount of manual data entry also minimizes data inaccuracies. Rather than rely on an auto-discovery approach, the present invention uses auto-data-entry. Data accuracy (“DA”) is related to the accuracy of manual data entry or automatic data entry. Electronic data transfer from one system to another does not ensure accuracy, but it does reduce the possibility of additional input errors.

Returning to the picture puzzle example, a picture puzzle is correct when all of the pieces are used and all of the pieces are fit together. When all of the pieces are identified and connected together, the likelihood increases that the picture is correct. If pieces are not identified or left unconnected, not only are pieces of the puzzle missing, but the pieces at the edges that do not have pieces connected may also be incorrect. A completed puzzle, with all the pieces fitting with each other, creates a closed-loop that increases the likelihood that the entire puzzle is connected together correctly. The approach in designing and using the present invention is to create a web of information that interlocks and therefore checks itself. Just as adding more assets to the systems increases value, adding more link characteristics increases accuracy.

Putting all of the improvement pieces together, a mathematical relationship related to the system accuracy and system value can be defined as follows:

System Accuracy and System Value Are Related To:

boundaries & assets;

people's goals;

business rules;

asset life cycle;

data entry accuracy; and

data verification.

Where,

Boundaries and Assets can be represented by:

$$\frac{actual assets in the IMS + actual related things in the IMS}{T + RT in the infrastructure}$$

People's goals can be represented by:

$$\frac{actual IMS users}{TU}$$

Business rules can be represented by:

$$\frac{actual asset links in IMS}{TL}$$

Asset life cycle can be represented by:

$$\frac{\begin{matrix}actual ( procurement + implementation + \\ change + disposal ) data in IMS\end{matrix}}{\begin{matrix}total ( procurement + implementation + \\ change + disposal ) data in infrastructure\end{matrix}}$$

Data entry accuracy can be represented by:

$$\frac{\begin{matrix}ABS [ actual automatic - entry accuracy - \\ actual manual - entry accruacy ]\end{matrix}}{\begin{matrix}maximum automatic - entry accruacy - \\ maximum manual - entry accuracy\end{matrix}}$$

Data verification can be represented by:

$$\frac{\begin{matrix}ABS [ actual automatic data verification - \\ actual manual data verification ]\end{matrix}}{\begin{matrix}maximum automatic data verification - \\ maximum manual data verification\end{matrix}}$$

System value and system accuracy increase as the actual variables increase toward the total variable values. The data accuracy and data verification influence on the system accuracy is improved as more automation is implemented.

The IMS process is independent of a particular embodiment of the IMS Software Program or the IMS Relational Database repository. Deficiencies in the software or database can affect the system usability or accuracy. Techniques to validate data elements, perform consistency checks, and allow for data repair are features that improve usability and therefore system accuracy. Added features such as searching, importing, exporting, or rich-text-printing improve the usability of the system. The easier the system is to use, the more likely people will use the system to accurately track infrastructure assets.

In summary, the method 238 for improving the database 111 may include the steps of adding additional assets, related items, attributes, users or increasing a boundary in the database 111 (block 218), customizing the database 111 (block 240) or upgrading the database 111 (block 242). More specifically, if the system value is to be increased, as determined in decision block 217, the system value is increased by adding more assets, related items, attributes, users or increasing the system boundaries in block 218. The system can again be used as described in FIG. 2B. If, however, the system value does not need to be increased, as determined in decision block 217, and the system accuracy needs to be increased, as determined in decision block 219, and the system accuracy is to be increased using new data input from other systems (data sources), as determined in decision block 220, special software interfaces can be designed to allow for auto-data-entry in block 221. The data sources may include a purchasing system, a financial system or a human resources system. Once these custom interfaces are designed and information transferred between systems, the system can again be used as described in FIG. 2B.

If, however, the system accuracy is not to be increased using new data input from other systems, as determined in decision block 220, and reporting or workflow is to be added to improve system accuracy, as determined in decision block 222, aggregate reporting or operation workflow is added in block 223. Once the reporting or operation workflow is added, the system can again be used as described in FIG. 2B. If, however, reporting or workflow is not to be added, as determined in decision block 222, and modifications to the link characteristics or business rules are to be modified to improve system accuracy, as determined in decision block 224, the new connection rules are added and the system is reconfigured in block 225, and the software interface (IMS Software 106 and/or IMS Relational Database repository 111) is upgraded or improved in block 226. Thereafter, system can again be used as described in FIG. 2B. Lastly, if changes to the actual total users (TU), number of assets (T), number of related things (RT), the number of connection links (TL), data accuracy (DA), or data verification (DV) are not sufficient and system accuracy still needs to be improved, as determined in decision blocks 217, 219 and 224, an upgrade or improvement to the IMS Software 106 and/or IMS Relational Database repository 111 is required in block 226. Thereafter, system can again be used as described in FIG. 2B.

As described, the methods illustrated in FIGS. 2A, 2B and 2C can be implemented using a computer program (IMS Software 109 (FIG. 1)) embodied on a computer readable medium wherein the steps are performed by one or more code segments.

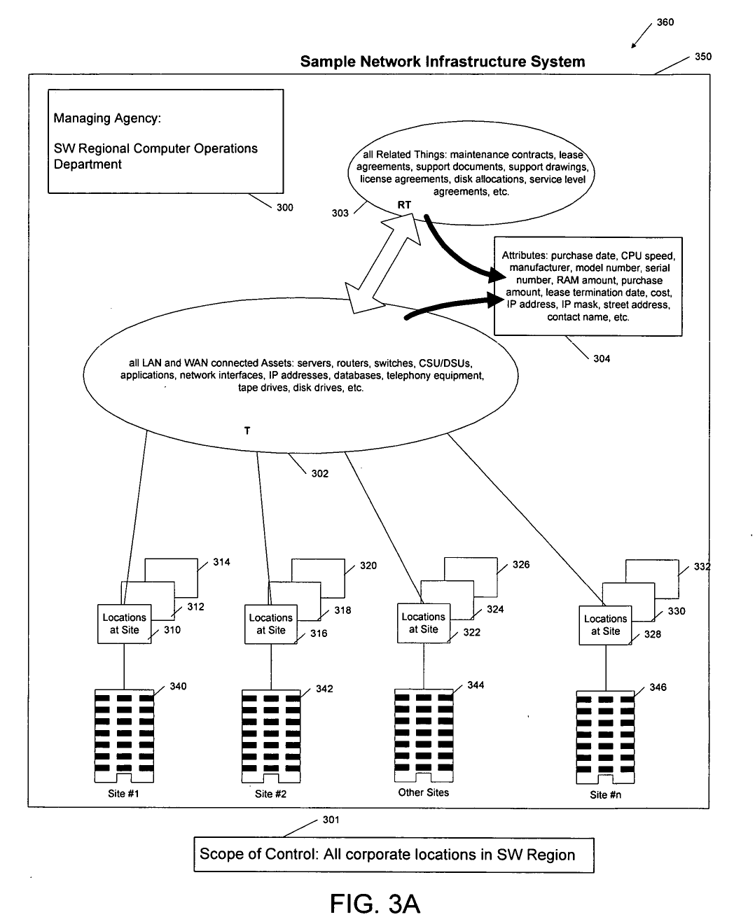

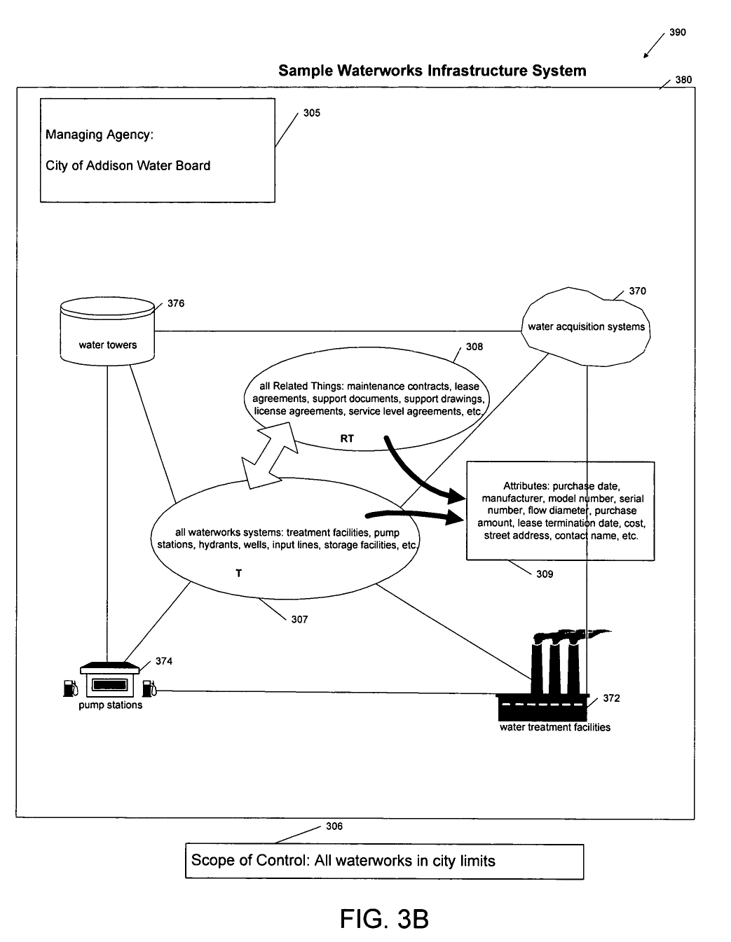

Now referring to FIG. 3A, a block diagram illustrating an example of the present invention as it is applied to a network infrastructure system 360 is shown. Using the present invention in this case, the managing agency 300 is identified as the Southwest Regional Computer Operations Department and their scope of interest 301 is defined as all corporate locations in the Southwest Region 350. The total list of assets (“T”) 302 are identified as all LAN and WAN connected assets: servers, routers, switches, CSU/DSUs, applications, network interfaces, IP addresses, databases, telephony equipment, tape drives, disk drives, etc. The related item or things (“RT”) 303 are identified as maintenance contracts, lease agreements, support documents, support drawings, license agreements, disk allocations, service level agreements, etc. For both assets 302 and asset related items 303, the attributes 304 are defined as the purchase date, central processing unit (“CPU”) speed, manufacturer, model number, serial number, random access memory (“RAM”) amount, purchase amount, lease termination date, cost, Internet protocol (“IP”) address, IP mask, street address, contact name, etc. As shown, the assets 302 are physically located at locations 310, 312, 314, 316, 318, 320, 322, 324, 326, 328, 330, 332 within a site 340, 342, 344, 346, within the Southwest Region 350, each site having multiple locations (Site #1 340 has locations 310, 312 and 314; Site #2 342 has locations 316, 318 and 320; Other Sites 344 has locations 322, 324 and 326; and Site #n 346 has locations 328, 330 and 332). This is the data that the organization wants to track within the IMS.

Referring now to FIG. 3B, a block diagram illustrating an example of the present invention as it is applied to waterworks infrastructure system 390. Using the present invention in this case, the managing agency 305 is identified as the City of Addison Water Board and their scope of interest 306 is defined as all waterworks in the city limits 380. The total list of assets (“T”) 307 is identified as all waterworks systems: treatment facilities, pump stations, hydrants, wells, input lines, storage facilities, etc. The related item or things (“RT”) 308 are identified as maintenance contracts, lease agreements, support documents, support drawings, license agreements, service level agreements, etc. For both assets 307 and asset related items 308, the attributes 309 are defined as the purchase date, manufacturer, model number, serial number, flow diameter, purchase amount, lease termination date, cost, street address, contact name, etc. As shown, the assets 307 are physically located at water acquisition systems 370, water treatment facilities 372, pump stations 374 and water towers 376, all of which are connected together within the city 380. This is the data that the organization wants to track within the IMS.

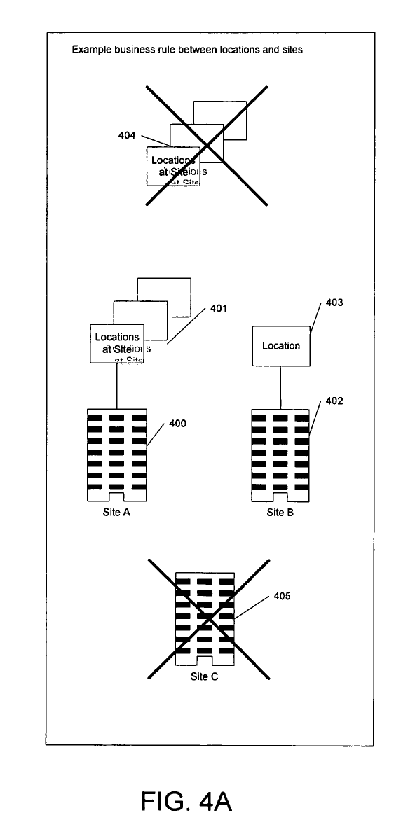

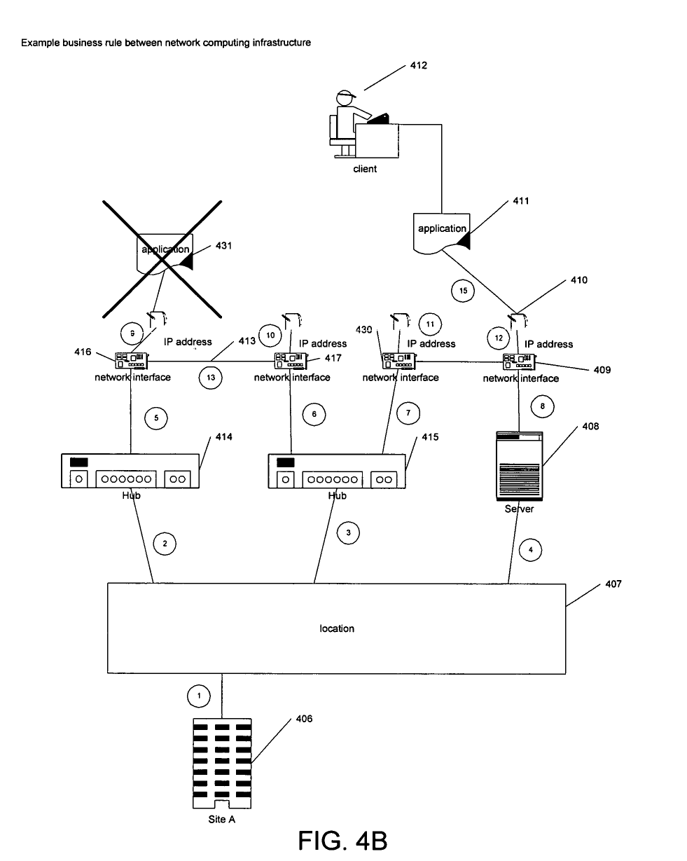

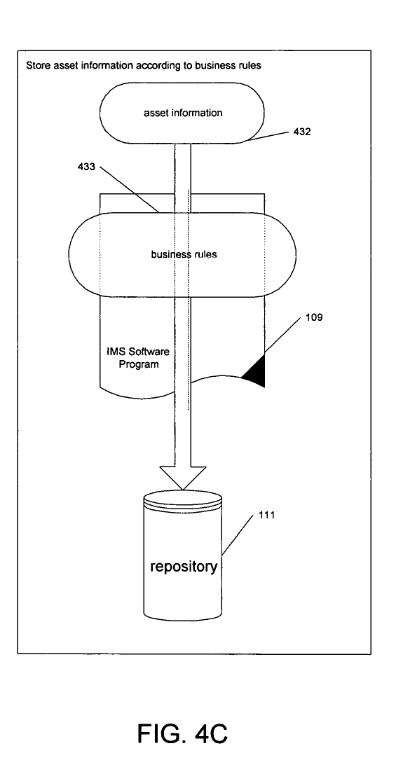

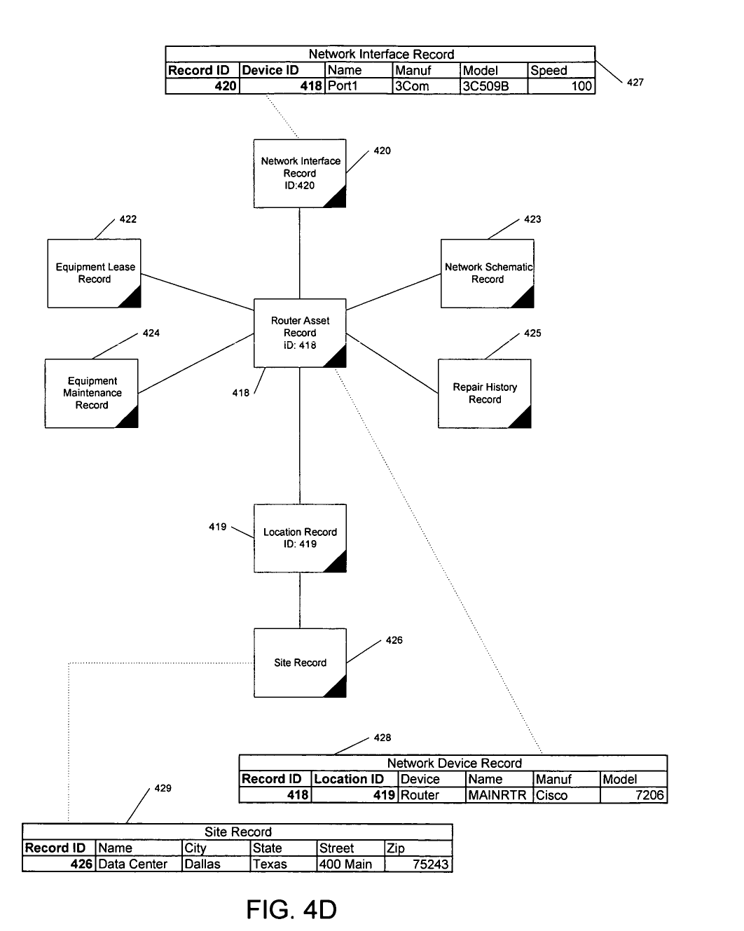

Now referring to FIGS. 4A, 4B, 4C and 4D, block diagrams illustrating the use of business rules in one embodiment of the present invention are shown. The organization that defines the boundaries of the infrastructure system also defines or knows of the rules for how the infrastructure elements interconnect. The boundaries of the infrastructure system identify a controlling organization and more importantly, identify a set of rules that define how the systems interconnect. For instance, a municipality, be it local, state or federal, defines the rules for how the water, road and telephone systems interconnect. Likewse, departments in an organization, including corporations, define how internal computer systems interconnect.

For example, FIG. 4A illustrates how business rules relate between locations and sites in a computer network infrastructure. The base element is a physical location of the network elements (Site A 400; Site B 402; and Site C 405)—a building or other place that houses the network device. Within those buildings (Site A 400 and Site B 402), are computer or network device locations 401 and 403, respectively. These locations are often network closets, computer rooms, lab rooms, inventory closets, or data centers. The business rule here is that a computing location (401, 403, 404) can only exist in buildings or other physical places (400, 402, 405). There can be a single location 403 or multiple locations 401 within a building, and there can be multiple buildings 400, 402, but a location 404 cannot exist unless it resides in a building or other physical place. Likewise, a site 405 without a location with network equipment does not exist within a network infrastructure asset system.

The business rules for device interconnections seldom change. Often, technological barriers need to be eliminated to change the business rules for how devices interconnect. For instance, telephone systems were exclusively wire line services until wireless communications were invented. Computers all had internal disk storage until storage area networks were invented. Likewise, until automobiles can fly, vehicular transportation systems operate on land-based systems. With each closed-loop infrastructure, there is a finite number of links within a system that we define as the total links (“TL”). The link is the relationship how the sub-elements interact.

Carrying the computer network infrastructure example further, FIG. 4B illustrates how business rules relate between network computing infrastructures. Site A 406 contains the network location 407 that includes two network hubs 414, 415 and a server 408. These devices 408, 414, 415 in turn have network interfaces 409, 416, 417, 430 attached. The business rule here is that each device may have one or more network interface. The network interfaces 409, 416, 417, 430 are then connected together. In this example, interface 416 to interface 417, and interface 430 to interface 409. The business rule continues where an IP address 410 is then added to the network interface 409. A client 412 uses an application 411, which is linked to network interface 409 in server 408. Another business rule is defined, where an application can be linked in a hierarchy related to a server network interface 409, but not to a network device network interface 431. In this sample network, there are 15 total links (TL) between infrastructure assets and sub-elements.

Referring now to FIG. 4C, an illustration of how asset information is stored according to one or more business rules is shown. The IMS Software Program 109 applies the business rules 433 associated with the asset when the asset information 432 is stored in the ISM Relational Database repository 111. This is done programmatically by only allowing entry of valid data relationships and by including relational links in the data records that relate the stored information of one sub-element to the other sub-elements that are related. For instance in the computer network scenario, the software would not allow entry of a location without it being related to an existing site. Likewise, the software would not allow information on a site without also recording information about at least one location within the site.

The ISM Software Program 109 creates data tables and data records that contain the attribute information about each asset, sub-element and related thing. Each of these records has a unique record identifier (“ID”). The ISM Software Program 109 will store these records in the ISM Relational Database repository 111 with sufficient unique record identifiers to relate each data record to their other related data records. The present invention stores asset data with relationships in the same physical or logical fashion as the devices are interrelated. In using this approach, the data pieces fit together, much like a puzzle, in a fashion that checks itself. The likelihood increases that a puzzle is correct when all of the pieces are included and they all interlock and fit neatly together.

Now referring to FIG. 4D, an example data relationship associated with a computer network router is shown. Information about the router 418 is stored first. This database record is created in a fashion 428 that includes a reference in the router data record 418 that incorporates a record identifier that relates to the location data record 419, associated with where the router is physically located. When assets or information about that asset are connected together according to the hierarchy, as they physically or logically exist, you can determine the location or information of one asset from its relation to other connected or interrelated assets. Information about a network interface connected to the router is saved as a separate data record 420 in a format 427 that relates to the router data record 418. Other data records 422, 423, 424, 425 that relate information to the router are also stored in a hierarchical manner that point to the related router asset record ID #418.

With the present invention, the addition of static business rules in the data capture process enhances the quality of the data. The interconnection relationship information gives records in the ISM repository more meaning than the record existing without the relationship. The relationship of how one data element interrelates to the other data elements is the added information value. For infrastructure systems, each asset is related to another asset and is within a system boundary. All assets connect through a hierarchy, related to a system boundary at the lowest level and related to a person at the upper-most level. No assets exist outside the boundaries of the infrastructure.

Take for instance the example shown in FIG. 4B. Information about the site 402 is related to a system boundary—a location within the geographic boundary of the managing agency (see FIG. 3A, 300, 301). The example application 411 is related to an IP address 410, and also related to a client group 412. Each element in the infrastructure is related to another element, to a system boundary, or to a person 412.

Take the example of the router asset record 418 in FIG. 4D. This information record is interconnected with several other information records 419, 420, 422, 423, 424, 425. There is a closed-loop around this data element, where removal of the router data record 418 affects the associated interrelated information records. As mentioned earlier, many other asset management systems focus on auto-discovery or auto-location techniques to identify the existence of an asset. Take for instance the router associated with the router asset record 418. This data record is related to a location record 419, which is in turn related to a site record 426. From the hierarchy defined by the ID pointers in the data records, you can determine that Router ID #418 is in Location ID #419, which is located in the Data Center, at 400 Main, Dallas, Tex. There is no need to auto-discover the location of asset devices with my invention, where asset information is stored in a closed-loop hierarchical fashion.

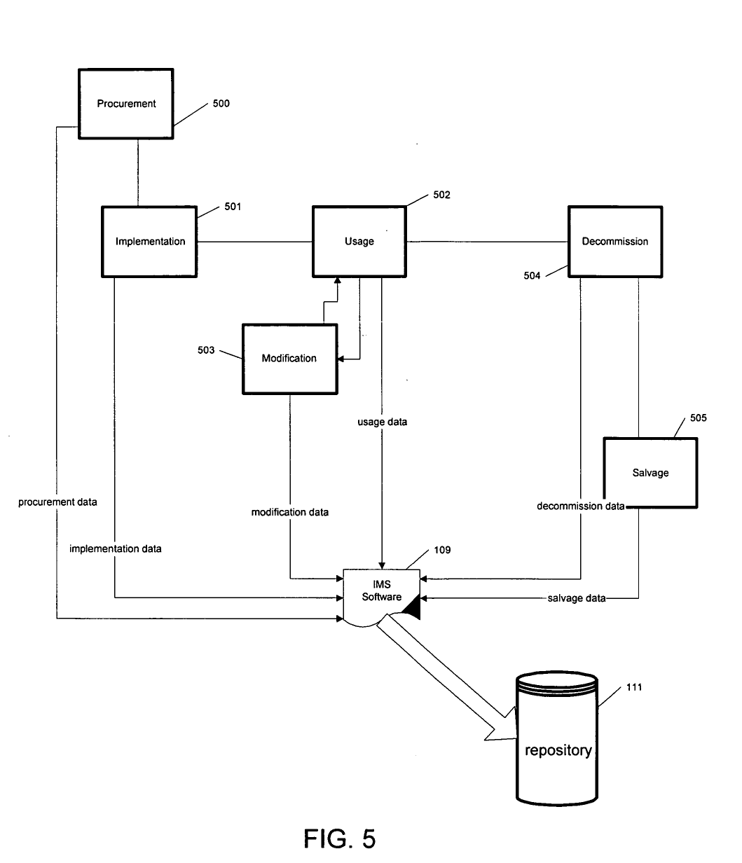

Referring now to FIG. 5, a block diagram illustrating the closed-loop life cycle of infrastructure assets in accordance with one embodiment of the present invention is shown. The IMS Software Program 109 allows system users to enter procurement 500, implementation 501, usage 502, modification 503, decommission 504, and salvage 505 information. The IMS Software Program 109 is used to store this information into the IMS Relational Database repository 111. This is another closed-loop. Once asset information is added to the system through a procurement process, it will remain in the system until it is salved.

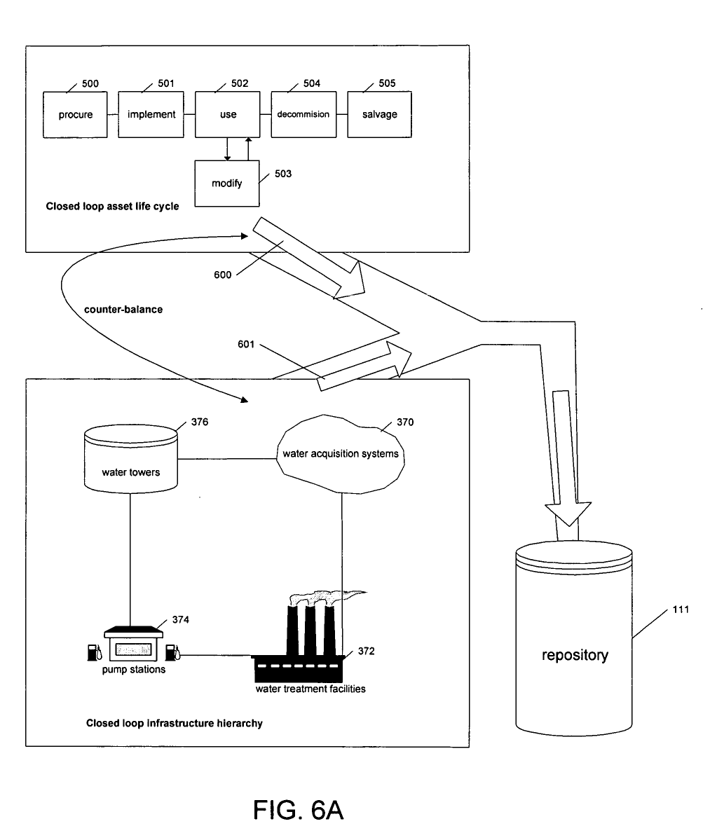

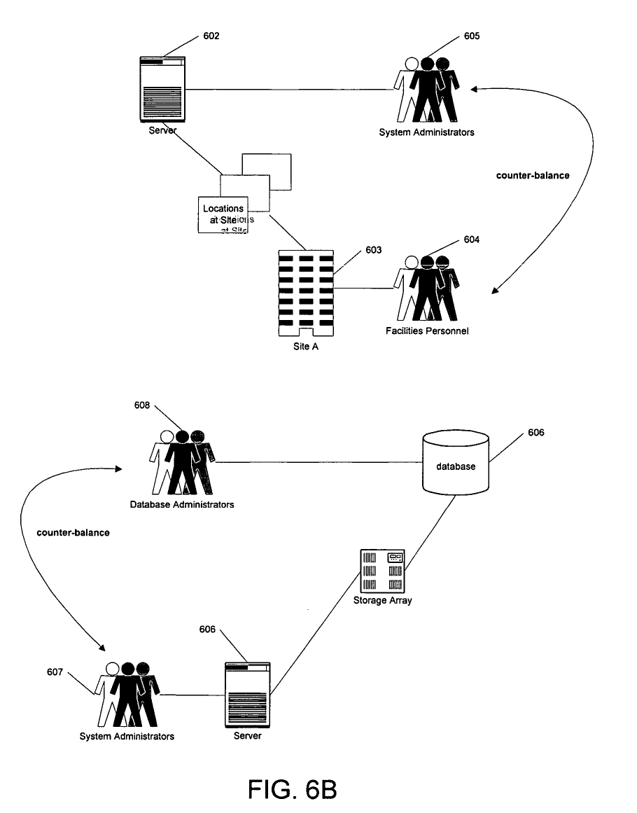

Now referring to FIG. 6A, a block diagram illustrating counter-balancing closed-loops in accordance with one embodiment of the present invention is shown. Both of the features: (1) to capture data at each life cycle change 600; and (2) to link the asset information in the same fashion as the business rules link sub-elements together 601 creates “counter-balancing, closed-loops” within the repository 111. A closed loop of information capture is created if data is put into the system at each point that the asset moves through its life cycle (procure 500, implement 501, use 502, modify 503, decommission 504 and salvage 505) (see also FIG. 5). Likewise, a closed loop of information is created if all infrastructure elements are put into the system and linked to each other in a manner, as the assets are physically interrelated (water acquisition systems 370, water treatment facilities 372, pump stations 374 and water towers 376) (see FIG. 4D). Having two closed loops forms a counter-balancing method that increases the accuracy of the entire infrastructure management system.

Referring now to FIG. 6B, a block diagram illustrating counter-balancing system users in accordance with one embodiment of the present invention is shown. Added data verification (“DV”) is a natural by-product of additional system users. Identification and addition of rival or competitive user groups—groups who rely on each other's data—helps ensure accuracy of the data. For example, the facilities personnel 604 could be required to maintain accurate up-to-date attribute information on sites 603. However, the system administrators 605 are required to support the servers located at the site. The system administrators require accurate information from the facilities department in order for them to have accurate information on where the server is located. Making the system administrators rely on the facilities personnel provides a counter-balancing effect. Likewise, the database administrators 608 rely on server information entered by the system administrators 607. The process to share the asset information to more people increases the value of the information and also provides an inherent check-and-balance system.

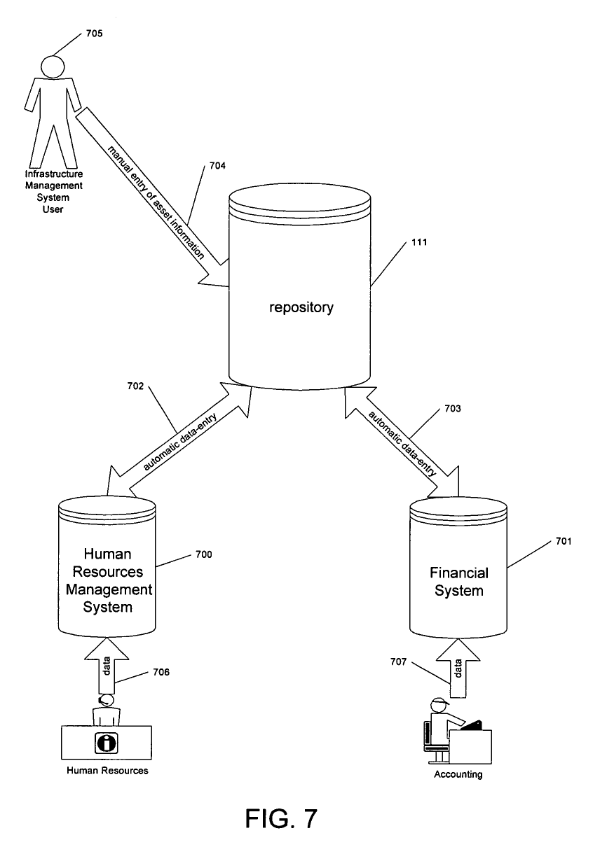

Now referring to FIG. 7, a block diagram illustrating entry of data the database from other sources in accordance with one embodiment of the present invention is shown. Often information maintained within the IMS is also maintained in other software systems. For instance, network system management platforms keep track of system events, providing alerts on device faults. Enterprise resource planning (ERP) and customer relationship management (CRM) systems keep track of people and customers. While there can be overlap in information maintained in these systems, my invention does not depend on the infrastructure management system being the central data repository. Here, automatic data feeds 702, 703 from the purchasing system, the financial system 701, or the human resources systems 700 can enhance the accuracy of the IMS. At a base level, someone or some technique is required to put information into each of these types of systems 706, 707. This information can be entered manually into each system 704, 706, 707, or they can be entered once and transferred automatically 702, 703 to the others. The accuracy of the IMS will ultimately rely on the accuracy of the data entered; no matter of the original data source, but the accuracy is improved when data entry is minimized.

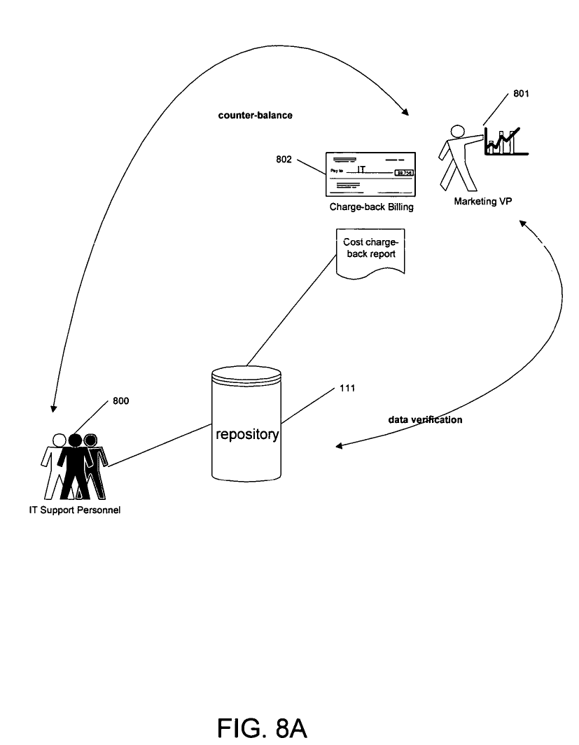

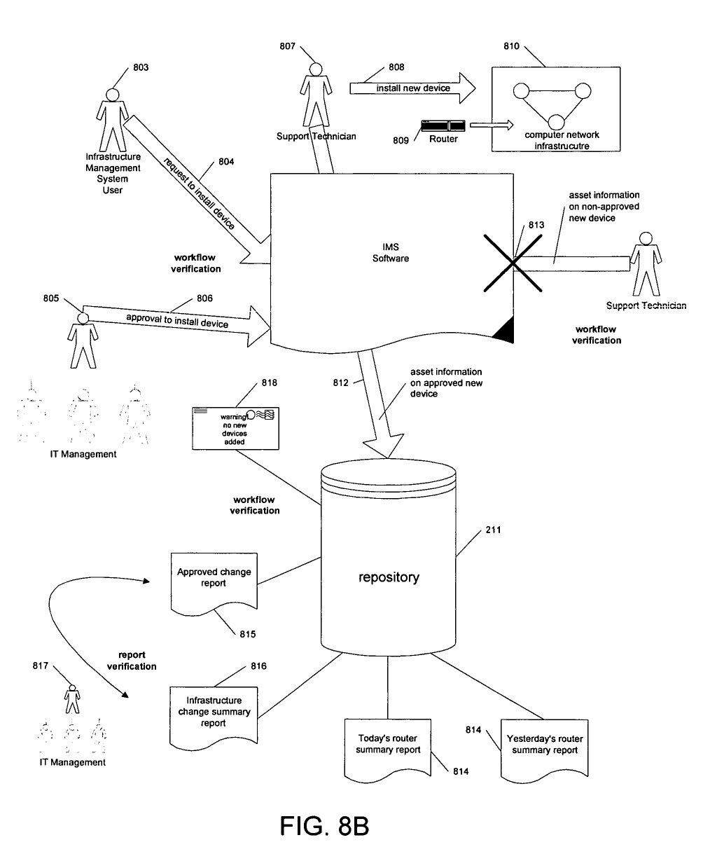

Referring now to FIGS. 8A and 8B, block diagrams illustrating various examples of data verification in accordance with one embodiment of the present invention are shown. System accuracy is improved if the data is verified. The data can certainly be verified through manual methods, but an operational approach is easier. The present invention incorporates techniques to constantly verify the data.

One fallacy from many asset management systems is that they are solely information repositories. The danger exists that data lays dormant in an inaccurate state, only being discovered when the information is retrieved. Like a library inventory tracking system, books can be misfiled and no one knows about it until someone tries and checkout the book.

Unlike the library example where the book elements do not interconnect or rely on each other, a computer data network is a closed loop. Using the present invention, the infrastructure could include routers, network switches, servers, disk space and applications. If information in the system were used for charging clients money for their use of the assets, the charge-back report 802 would be an item that naturally helps verify the accuracy of the underlying system. The managing agency 800 would want to include as many of the assets in the report as possible, and the charged agency 801 would want the report to include as few assets as possible. The counter-balancing interests of the two organizations serve to verify the data within the infrastructure management system. Adding numerous reporting workflows activities will increase the accuracy of the data in the system.

The present invention also includes workflow that constantly checks the data in the system. This is not workflow that verifies the data, but workflow that ensures that people rely on the data for daily operations. With this approach, the people will verify the data contemporaneously. An aggregate report or workflow on the changes in the system serves to verify the data. If a new switch is added to the infrastructure, the aggregate report should list an additional switch. Since the system is a closed-loop hierarchy, reporting should identify the other associated changes—added network links, new purchase or implementation information, or new server connections.

These are operational checks and balances that constantly verify the data accuracy. This step can be accomplished by adding features such as change management workflow, financial charge-back reporting, service-level reporting, management reporting, and capacity planning reporting. Rather than use manual methods to verify the data, a more economical approach is to verify the data in an operational mode. When the data in the IMS is used on a constant basis, people will naturally identify and correct errors in order to accomplish their day-to-day duties. When organizations use the data in the repository to operate and service the infrastructure, the data will be reviewed and verified in an on-going sense.

Since people ultimately use the assets or use the asset information, there is always workflow or reporting that can be created to verify the accuracy of the data. Remember, the information in the IMS is valuable only because people use it. Conversely, nothing is in the IMS that has no value—each element is valuable to someone and a report or workflow can be created that allows these individuals to validate the data elements.

Imagine an employee reward system where infrastructure support people are compensated or given merit raises based on the number of successful changes they implement on the infrastructure. Using the present invention, incorporation of a change management workflow and specific reporting helps validate the system. Here, the department workflow would require that the support person 803 make a request 804 within the IMS to schedule an infrastructure change, say the addition of a new router. The workflow would then require the manager 805 to approve the change 806. The support technician 807 then installs 808 the router 809 to the infrastructure 810 at the scheduled time. Because the change is approved, the IMS Software Program could be programmed to allow the support technician to make the associated changes in the IMS repository within 24 hours of the time the change was scheduled. Conversely, the IMS Software Program would not allow 813 changes to asset records if the change was not previously approved. Management reporting workflow 814 can verify that a new router was added to the infrastructure. Also, a report can list the changes that were scheduled 815 for the week, which can be manually compared 817 to the actual system changes 816.

One improvement would be to add an automated alerting workflow, whereby if the IMS was not updated with the information change within 24 hours, the IT manager 805 would get an automated e-mail alert 818. This is an exception reporting workflow, where system accuracy errors are flagged and reported. Again, if the proposed employee reward system were included, the support technician would have an incentive to update the IMS, helping keep the system accurate. Or conversely, the manager could punish the support technician if he neglected to update the IMS within the allotted timeframe.

Accordingly, errors can be reduced by validating any database records that are added, modified or deleted, limiting the data that can be stored in the one or more data fields, checking the data stored in the one or more data fields, checking the links to other records in accordance with the one or more business rules, or creating a workflow report.

Returning to the example of FIG. 4A of a business rule in a computer network infrastructure, a Site must have at least one Location FIG. 4a. The business rule could be defined differently, where devices are identified only as being located in a Site. The Location Designation provides added specificity and therefore added accuracy, but the system could have been designed without that added clarity. If the Location Designation was not included in the business rules, a device in the infrastructure could be physically moved anywhere in the site without a requirement to update the IMS for accuracy.

Likewise in the example of FIG. 4B of a computer network infrastructure that described a link 413 between the network interface 416 of one hub, and network interface 417 of another hub. If in reality, this link physically has patch panel connections between the network interfaces, the IMS could also track those inter-connections. Here, adding the patch-panel connections to show cabling interconnections increases system accuracy.

There are certainly cost trade-offs on how much detail is provided in the IMS, but the relationship exists that the more specificity is added, the more accurate the system becomes. The method to add more specificity increases the accuracy of the system, but IMS users must decide how much detail they want to include. The trade-off is between detail and higher accuracy, verses simplicity and reduced accuracy.

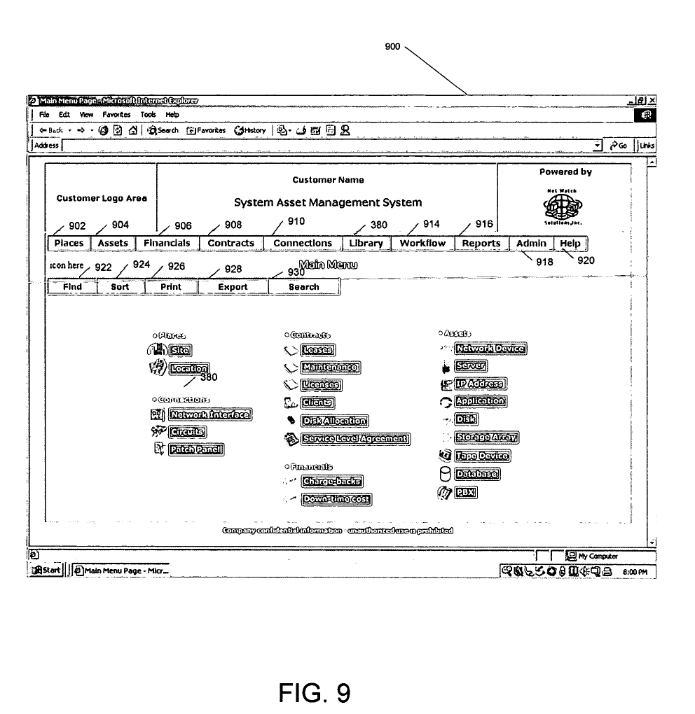

FIG. 9 is a screen shot 900 of a system asset management system in accordance with one embodiment of the present invention. The user can access various drop down menus relating to places 902, assets 904, financials 906, contracts 908, connections 910, libraries 912, workflow 914, reports 916, administration 918 and help 920. The user can perform various database functions, such as find 922, sort 924, print 926, export 928 or search 930. The user can access information about places (site and location), connections (network interface, circuits and patch panel), contracts (leases, maintenance, licenses, clients, disk allocation and service level agreements), financials (charge-backs and down-time cost) and assets (network device, server, IP address, application, disk, storage array, tape device, database and PBX) by clicking on the various links.

While the preceding description shows and describes one or more embodiments, it will be understood by those skilled in the art that various changes in form and entail may be made therein without departing from the spirit and scope of the present disclosure. Therefore, the claims should be interpreted in a broad manner, consistent with the present disclosure.

What is claimed is:

1. An apparatus for managing an infrastructure comprising:
a computer;
a user interface communicably coupled to the computer;
a database communicably coupled to the computer, the database containing two or more records, each record having a unique identifier and one or more data fields representing attributes of an asset or asset related item within the infrastructure, and all the records are linked to one another in a closed-loop hierarchical manner in accordance with one or more business rules; and
a computer program embodied on a computer readable medium that is executed by the computer to manage the infrastructure using the database.

2. The apparatus as recited in claim 1, wherein the one or more data fields further represent attributes of a sub-element for one or more assets.

3. The apparatus as recited in claim 1, wherein the attributes include an asset name, manufacturer name, make, model number, serial number, description, purchase date, expiration date, purchase cost or operating characteristics.

4. The apparatus as recited in claim 1, wherein the asset related items include places, connections, contracts, documentation or financials.

5. The apparatus as recited in claim 4, wherein the places include physical sites or locations.

6. The apparatus as recited in claim 4, wherein the connections include electrical connections, physical connections, logical connections, communication links, interfaces, junctions, circuits or patch panels.

7. The apparatus as recited in claim 4, wherein the contracts include leases, title documents, maintenance contracts, license agreements, clients contracts, resource allocation or service-level agreements.

8. The apparatus as recited in claim 4, wherein the documentation includes support documents, maintenance schedules, procedural documentation, operational documentation or policy documentation.

9. The apparatus as recited in claim 4, wherein the financials include purchase records, repair records, warranties, operational costs, charge-backs or down-time costs.

10. The apparatus as recited in claim 1, wherein each record includes life cycle information about the asset or asset related item.

11. The apparatus as recited in claim 1, wherein the one or more business rules define how the assets and asset related items are interconnected or how one or more users use the assets and asset related items or how one or more users use the information stored in the one or more data fields associated with the assets and asset related items.

12. A method for managing an infrastructure comprising the steps of:
providing a database containing two or more records, each record having a unique identifier and one or more data fields representing attributes of an asset or asset related item within the infrastructure, and all the records are linked to one another in a closed-loop hierarchical manner in accordance with one or more business rules;
processing one or more user requests to display or report information stored in the database; and
updating the database as assets or asset related items are procured, implemented, changed or disposed.

13. The method as recited in claim 12, further comprising the step of creating the database.

14. The method as recited in claim 13, wherein the step of creating the database comprises the steps of:
identifying one or more boundaries for the infrastructure;
identifying the assets within the boundaries;
identifying the items related to the assets;
determining the attributes associated with each asset and asset related item;
determining the business rules for how the assets and related items are linked together; and
creating each record and storing the record in the database ina losed-loop hierarchical manner in accordance with the business rules.

15. The method as recited in claim 14, further comprising the steps of:
determining one or more sub-elements for the assets and one or more attributes associated with the sub-elements; and
determining one or more business rules for how the sub-elements and assets are linked together.

16. The method as recited in claim 14, further comprising the step of identifying one or more people who use the assets.

17. The method as recited in claim 14, further comprising the step of identifying one or more people who use information about the asset.

18. The method as recited in claim 14, further comprising the step of designing data display and report formats.

19. The method as recited in claim 14, further comprising the steps of:
identifying a managing agency; and
determining one or more goals for the managing agency.

20. A computer program embodied on a computer readable medium for managing an infrastructure, the computer program comprising:
a code segment for providing a database containing two or more records, each record having a unique identifier and one or more data fields representing attributes of an asset or asset related item within the infrastructure, and all the records are linked to one another in a closed-loop hierarchical manner in accordance with one or more business rules;
a code segment for processing one or more user requests to display or report information stored in the database; and
a code segment for updating the database as assets or asset related items are procured, implemented, changed or disposed.
